(19) United States
(12) Patent Application Publication
(10) Pub. No.: US 2004/0225771 A1
(43) Pub. Date: Nov. 11, 2004

(54) Data pre-fetch control mechanism and method for retaining pre-fetched data after PCI cycle termination

(76) Inventors: Robert J. Riesenman, Sacramento, CA (US); Michael N. Derr, El Dorado Hills, CA (US)

Correspondence Address: ATTEN: JEFFREY B. HUTER, BLAKELY, SOLOLOFF, TAYLOR & ZAFMAN LLP, 12400 WILSIRE BOULEVARD, SEVENTH FLOOR, LOS ANGELES, CA, 90025, US

(21) Appl. No.: 09/749,432

(22) Filed: Dec. 28, 2000

(51) Int. Cl. G06F 13/00; G06F 13/38

(52) U.S. Cl. 710/200

(57) ABSTRACT

A data pre-fetch control mechanism of a host chipset is disclosed for fetching data from a memory subsystem of a computer system and retaining pre-fetched data based on Peripheral Component Interconnect (PCI) cycle termination. Such a data pre-fetch control mechanism comprises an interface control logic arranged to interface with a PCI bus; a data FIFO arranged to store pre-fetched data from a main memory to a requesting PCI device, via said PCI bus; and a pre-fetch control logic operatively connected to the interface control logic and the data FIFO, and arranged to control data fetch operations and retain pre-fetched data after on PCI cycle termination to optimize PCI bus operations and performances.

### TECHNICAL FIELD

The present invention relates to data fetching (or pre-fetching), and more particularly, relates to a data fetch (pre-fetch) control mechanism and method of retaining pre-fetched data based on Peripheral Component Interconnect (PCI) cycle termination.

### BACKGROUND

Generally computer systems have utilized one or more buses as an interconnect transportation mechanism to transfer data between different internal components, such as one or more processors, memory subsystems and input/output (I/O) devices including, for example, keyboards, input mouses, disk controllers, serial and parallel ports to printers, scanners, and display devices. For computer systems using processors such as the 8088, 8086, 80186, i386™ and i486™ microprocessors designed and manufactured by Intel Corporation, such buses have typically been designed as either an Industry Standard Architecture (ISA) bus or an Expanded Industry Standard Architecture (EISA) bus. The ISA bus is a sixteen (16) bit data bus while the EISA bus is thirty-two (32) bits wide. Each of these buses functions at a frequency of eight (8) megahertz. However, the data transfer rates provided by these bus widths and operational frequencies have been limited.

For recent computer systems, such as servers, workstations or personal computers (PCs) using a “Pentium®” family of microprocessors (manufactured by Intel Corporation), for example, such buses may be Peripheral Component Interconnect (PCI) buses. The PCI buses are high performance 32 or 64 bit synchronous buses with automatic configurability and multiplexed address, control and data lines as described in the latest version of “PCI Local Bus Specification, Revision 2.2” set forth by the PCI Special Interest Group (SIG) on Dec. 18, 1998. Currently, the PCI architecture provides the most common method used to extend computer systems for add-on arrangements (e.g., expansion cards) with new video, networking, or disk memory storage capabilities.

When PCI buses are used as an interconnect transportation mechanism in a host system (e.g., server, workstation or PC), data transfer between a processor, a memory subsystem and I/O devices may be executed at high speed. Bridges may be provided to interface and buffer transfers of data between the processor, the memory subsystem, the I/O devices and the PCI buses. Examples of such bridges may include PCI-PCI bridges as described in detail in the “PCI-PCI Bridge Architecture Specification, Revision 1.1” set forth by the PCI Special Interest Group (SIG) on Apr. 5, 1995. However, the performance of such a host system may be burdened by a significant amount of time required to process read requests from PCI devices (e.g., I/O devices that conform to the PCI Local Bus Specification for operation) to access memory locations of the memory subsystem, via the PCI buses, during data memory read operations. Existing data fetch (or pre-fetch) schemes for PCI devices, however, fail to optimize PCI bus operations and performances. Memory fetch latencies remain a problem. Likewise, pre-fetch traffics are typically wasted on system interfaces between PCI devices and the memory subsystem. As a result, memory read operations may not be maximized, and the wait time between memory read operations may be unnecessarily lengthened.

Accordingly, there is a need for an efficient data pre-fetch control mechanism which fetches data from a memory subsystem on one side of a host bridge to PCI devices on the other side of the host bridge and efficiently retains pre-fetched data based on PCI cycle termination in order to optimize PCI bus operations and performances with minimal logic gates.

### BRIEF DESCRIPTION OF THE DRAWINGS

A more complete appreciation of exemplary embodiments of the present invention, and many of the attendant advantages of the present invention, will become readily apparent as the same becomes better understood by reference to the following detailed description when considered in conjunction with the accompanying drawings in which like reference symbols indicate the same or similar components, wherein:

FIG. 1A illustrates an example computer system platform having an example data pre-fetch control mechanism incorporated therein according to an embodiment of the present invention;

FIG. 1B illustrates an example computer system platform having an example data pre-fetch control mechanism incorporated therein according to another embodiment of the present invention;

FIG. 2 illustrates a flow chart of an example data fetch (pre-fetch) operation performed by an existing data pre-fetch control scheme;

FIG. 3 illustrates an example data pre-fetch control mechanism for fetching data from a main memory to PCI devices according to an embodiment of the present invention;

FIG. 4 illustrates a flow chart of an example data fetch (pre-fetch) operation performed by an example data pre-fetch control mechanism according to an embodiment of the present invention; and

FIG. 5 illustrates a flow chart of an example data fetch (pre-fetch) operation performed by an example data pre-fetch control mechanism according to another embodiment of the present invention.

### DETAILED DESCRIPTION

The present invention is applicable for use with all types of system and peripheral buses, bridges and chipsets, including chipsets with I/O controller hubs (ICH1, ICH2 and ICH3) and PCI 64-bit hubs (P64Hs) and follow-on products, and new chipsets having internal buffers and data fetching control logics incorporated therein and new computer platforms which may become available as computer technology develops in the future. However, for the sake of simplicity, discussions will concentrate mainly on exemplary use of a PCI bus and a PCI-PCI bridge, although the scope of the present invention is not limited thereto.

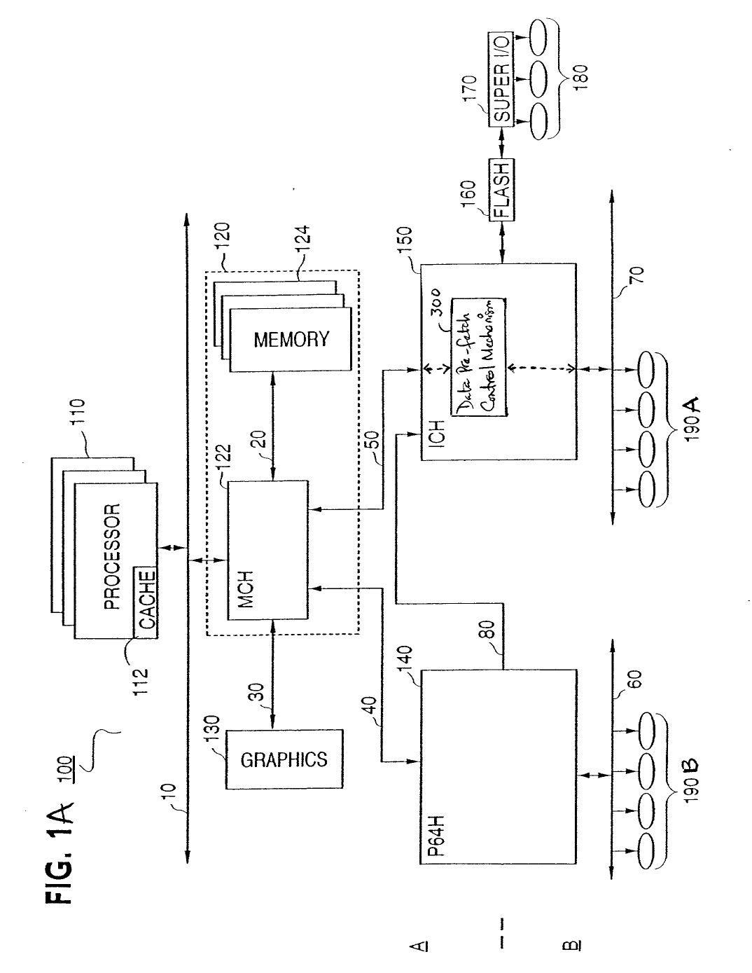

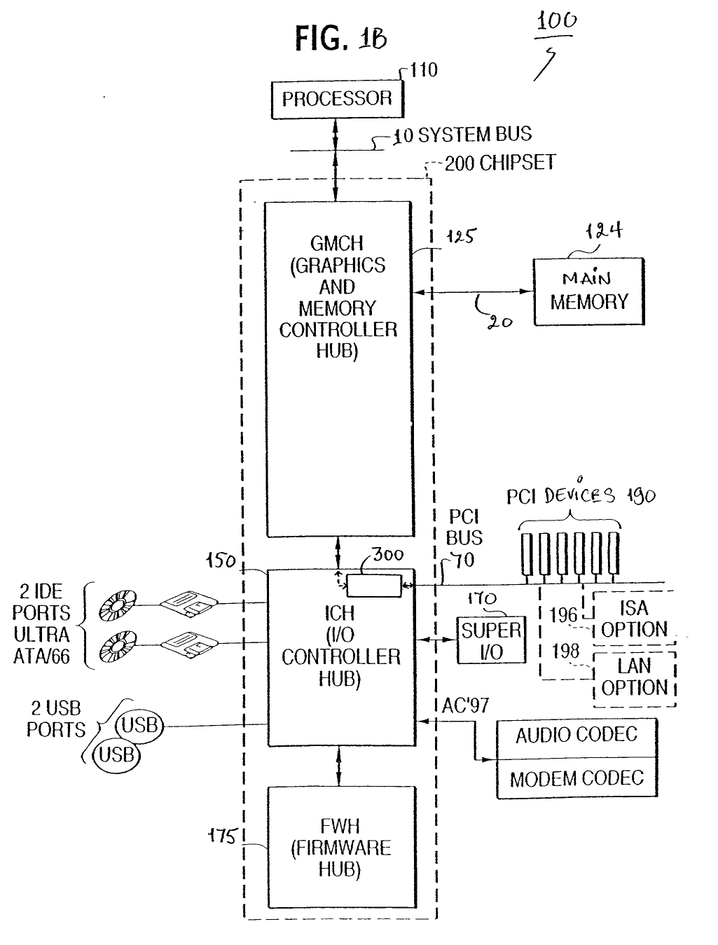

Attention now is directed to the drawings and particularly to FIGs. 1A-1B, an example computer system platform having an example data pre-fetch control mechanism incorporated therein according to different embodiments of the present invention is illustrated. As shown in FIG. 1A, the computer system 100 may comprise a processor subsystem 110, a memory subsystem 120, connected to the processor subsystem 110 by a front side bus 10, graphics 130 connected to the memory subsystem 120 by a AGP or graphics bus 30, one or more chips 140-150 connected to the memory subsystem 120 by hub links 40 and 50 for providing an interface with peripheral buses such as Peripheral Component Interconnect (PCI) buses 60 and 70 of different bandwidths and operating speeds, a flash memory 160, and a super I/O 170 connected to the chipset 150 by a low pin count (LPC) bus for providing an interface with a plurality of I/O devices 180, including, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers, scanners, and display devices. A different plurality of I/O devices 190A and 190B may be provided by the non-legacy PCI buses 60 and 70. In addition, it may be noted that the computer system 100 may be configured differently or employ some or different components than those shown in FIG. 1.

The processor subsystem 110 may include one or more host processors 110a-110n and a cache subsystem 112. The memory subsystem 120 may include a memory controller hub (MCH) 122 connected to the host processors 110a-110n by a front side bus 10 (i.e., host or processor bus) and at least one main memory element 124 connected to the MCH 122 by a memory bus 20. The main memory 124 may preferably be a dynamic random-access-memory (DRAM), but may be substituted for read-only-memory (ROM), video random-access-memory (VRAM) and the like. The main memory 124 stores information and instructions for use by the host processors 110a-110n. The graphics 130 may be connected to the main controller hub 122 of the memory subsystem 120 by an AGP bus (graphics bus) 30, and may include, for example, a graphics controller, a local memory and a display device (e.g., cathode ray tube, liquid crystal display, flat panel display, etc.).

The chips 140 and 150 may be Peripheral Component Interconnect (PCI) bridges (e.g., host, PCI-PCI, or standard expansion bridges) in form of PCI chips such as, for example, the PIIX4® chip manufactured by Intel Corporation. In particular, the chips 140 and 150 may correspond to a Peripheral Component Interconnect (PCI) 64-bit hub (P64H) 140 and an input/output controller hub (ICH) 150. The P64H 140 and the ICH 150 may be connected to the MCH 122 of the memory subsystem 120 respectively by 16 bits and 8 bits hub links 40 and 50, for example, and may operate as an interface between the front side bus 10 and peripheral buses 60 and 70 such as PCI buses of different bandwidths and operating speeds. The PCI buses may be high performance 32 or 64 bit synchronous buses with automatic configurability and multiplexed address, control and data lines as described in the latest version of “PCI Local Bus Specification, Revision 2.2” set forth by the PCI Special Interest Group (SIG) on Dec. 18, 1998 for add-on arrangements (e.g., expansion cards) with new video, networking, or disk memory storage capabilities. For example, the PCI bus 60 of 64-bits and 66 MHz may connect to the P64H 140. Similarly, the PCI bus 70 of 32-bits and 33 MHz may connect to the ICH 150. The PCI bus 70 may also be 64-bits or higher for supporting an operating frequency of 66 MHz or higher. Other types of bus architecture such as Industry Standard Architecture (ISA) and Expanded Industry Standard Architecture (EISA) buses may also be utilized.

In one embodiment of the present invention, the hub links 40 and 50 which connect the P64H 140 and the ICH 150 to the MCH 122 of the memory subsystem 120 may be primary PCI buses of different bandwidths and operating speeds. The peripheral buses 60 and 70 which connect the P64H 140 and the ICH 150 to I/O devices may be secondary PCI buses different bandwidths and operating speeds. The P64H 140 and ICH 150 may correspond to PCI-PCI bridges designed for compliance with the “PCI Local Bus Specification, Revision 2.2” set forth by the PCI Special Interest Group (SIG) on Dec. 18, 1998, and the “PCI Bus Power Interface (ACPI) and Power Management Interface Specification, Revision 1.1” set forth by the PCI Special Interest Group (SIG) on Jun. 30, 1997.

Either the P64H 140 or the ICH 150 may include a data pre-fetch control mechanism 300 arranged according to an embodiment of the present invention to control data transfers among the processors 110a-110n, the main memory 124 of the memory subsystem 120 and the PCI bus 60 or 70, including fetching data from the main memory 124 of the memory 5 subsystem 120 in response to requests from PCI devices 190A-190B (i.e., I/O devices connected to the PCI bus) via the PCI bus 60 or 70. In addition, either the P64H 140 or the ICH 150 may also include circuitry for interfacing the processor 110 and the main memory 124, and circuitry for interfacing to the PCI bus 60 or 70.

Data pre-fetch control mechanism 300 may be integrated within either the P64H 140 or the ICH 150 (as shown in FIG. 1A but not limited thereto) rather than provided as a separate chip within a host chipset for simplicity. Connected to the PCI bus 60 or 70 may be a group of PCI devices (I/O devices) 190A-190B, including, for example, multiple high performance peripherals in addition to graphics (motion video, LAN, SCSI, FDDI, hard disk drives, etc.). Also connected to the PCI bus 60 or 70 may be additional secondary bridges for providing data transfers between the PCI bus 60 or 70 and a secondary bus so that the data may be used by various component circuits joined to the secondary bus. The secondary bus may be an ISA bus, an EISA bus, or a similar bus, any of which typically transfers data at a rate slower than the PCI bus 60 or 70. Examples of secondary bridges may include those described in detail in a publication entitled “82420/82430 PCIset, ISA and EISA Bridges,” in 1993, Intel Corporation.

ICH 150 may further include a direct memory access (DMA) controller (not shown), a timer (not shown), an interrupt controller (not shown) such as an Intel 8259 PIC, universal serial bus (USB) ports and IDE ports for providing an interface to a hard disk drive (HDD) and compact disk read-only-memory (CD-ROM). In addition, the P64H 140 may optionally include an IO Advanced Programmable Interrupt Controller (APIC) of an APIC system for handling additional interrupts from a PCI bus 70, if additional interrupts are required.

The flash memory (e.g., EPROM) 160 and the super I/O 170 may be connected to the ICH 150 via a low pin count (LPC) bus. The flash memory 160 may store a set of system basic input/output start up (BIOS) routines at startup of the computer system 100. The super I/O 170 may provide an interface with a group of I/O devices 180, including, for example, a keyboard controller for controlling operations of an alphanumeric keyboard, a cursor control device such as a mouse, track ball, touch pad, joystick, etc., a mass storage device such as magnetic tapes, hard disk drives (HDD), floppy disk drives (FDD), and serial and parallel ports to printers, scanners, and display devices.

Alternatively, the memory controller hub (MCH) 122, the graphics 130 and the I/O controller hub (ICH) 150 may be integrated as a single graphics and memory controller hub (GMCH) implemented as a PCI chip such as, for example, PIIX4® chip and PIIX6® chip manufactured by Intel Corporation. Such a GMCH may also be implemented as part of a host chipset along with an I/O controller hub (ICH) and a firmware hub (FWH) as described, for example, in Intel® 810 and 8XX series chipsets as described with reference to FIG. 1B.

FIG. 1B illustrates an example computer system 100 including such a host chipset 200. The computer system 100 includes essentially the same components shown in FIG. 1A, except for the host chipset 200 which provides a highly-integrated three-chip solution consisting of a graphics and memory controller hub (GMCH) 125, an input/output (I/O) controller hub (ICH) 150 and a firmware hub (FWH) 175.

GMCH 125 maybe, for example, an Intel® 82810 or 82810-DC100 chip which incorporates therein graphics for graphics applications and video functions and for interfacing one or more memory devices to the system bus 10, and may be interconnected to any of a main memory 124 via a memory bus 20, and other components such as a local memory (not shown), a display monitor (not shown) via an encoder and a digital video output signal. Such a GMCH 125 also operates as a bridge or interface for communications or signals sent between one or more processors 110 and one or more PCI devices 190 which may be connected to ICH 150.

ICH 150 interfaces one or more PCI devices 190 to GMCH 125. FWH 175 is connected to the ICH 150 and provides firmware for additional system control. The ICH 150 may correspond, for example, an Intel® 82801 chip. Likewise, the FWH 175 may correspond, for example, an Intel® 82802 chip.

ICH 150 may be connected to a variety of I/O devices and the like, such as: a Peripheral Component Interconnect (PCI) bus 70 (PCI Local Bus Specification Revision 2.2) which may have one or more PCI devices 190 serving as I/O devices connected to PCI slots, an Industry Standard Architecture (ISA) bus option 196 and a local area network (LAN) option 198; a Super I/O chip 170 for connection to a mouse, keyboard and other peripheral devices (not shown); an audio coder/decoder (Codec) and modem Codec; a plurality of Universal Serial Bus (USB) ports (USB Specification, Revision 1.0); and a plurality of Ultra/66 AT Attachment (ATA) 2 ports (X3T9.2 948D specification; commonly also known as Integrated Drive Electronics (IDE) ports) for receiving one or more magnetic hard disk drives or other I/O devices.

The USB ports and IDE ports may be used to provide an interface to a hard disk drive (HDD) and compact disk read-only-memory (CD-ROM). I/O devices and a flash memory (e.g., EPROM) may also be connected to the ICH 150 of the host chipset 200 for extensive I/O supports and functionality. Those I/O devices may include, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers and scanners. The flash memory (not shown) may be connected to the ICH 150 of the host chipset 200, via a low pin count (LPC) bus, to store a set of system basic input/output start up (BIOS) routines at startup of the computer system 100. The super I/O chip 170 may provide an interface with another group of I/O devices.

In either platform embodiment of an example computer system as described with reference to FIGs. 1A-1B, existing data fetch (pre-fetch) control schemes may be utilized to fetch data from main memory 124 of the memory subsystem 120 on one side (side A) of the ICH 150, for example, in response to requests from PCI devices 190, via the PCI bus 70, on the other side (side B) of the ICH 150.

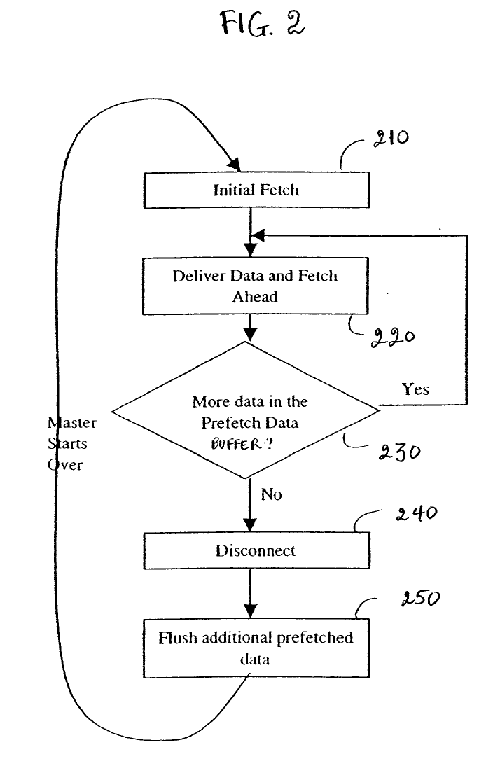

For example, FIG. 2 illustrates a flow chart of an example data fetch (pre-fetch) operation performed by an existing data pre-fetch control algorithm installed at existing Intel Chipsets. As shown in FIG. 2, when a PCI read request is received from a PCI master (PCI device) 190 at the ICH 150 for a data fetch (pre-fetch) operation at block 210, the ICH 150 fetches data from the main memory 124 into an internal buffer (not shown) and delivers pre-fetched data stored in the internal buffer (not shown) to the requesting PCI master 190, via the PCI bus 70. While delivering data to the PCI master 190, the ICH 150 also fetches data ahead from the main memory 124 pursuant to the PCI read request from the PCI master 190 at block 220.

Next, the ICH 150 determines whether there is more pre-fetched data stored in the internal buffer at block 230. If there is more pre-fetched data stored in the internal buffer (not shown) at block 230, the ICH 150 continues to deliver pre-fetched data to the PCI master 190, via the PCI bus 70 and fetches data ahead from the main memory 124 at block 220 until there is no more pre-fetched data stored in the internal buffer (not shown) at block 230. When there is no more pre-fetched data stored in the internal buffer (not shown) at block 230, the ICH 150 disconnects the transaction at block 240, and flushes any additional pre-fetched data which may arrive to the internal buffer (not shown) at some later time due to memory fetch latencies at block 250. Using existing data pre-fetch control algorithms installed in the ICH 150, the pre-fetched data is always flushed from the internal buffer (not shown) of the ICH 150 at each and every PCI cycle termination. Otherwise, data left over may block data path and cause deadlock in the computer system.

However, existing data fetch (or pre-fetch) control schemes for PCI devices 190 do not optimize PCI bus operations and performances. Memory fetch latencies remain a problem. Likewise, pre-fetch traffics are typically wasted on system interfaces between PCI devices 190 and the memory 124 of the memory subsystem 120. As a result, memory read operations are not maximized, and the wait time between memory read operations may be unnecessarily lengthened.

In many cases, additional data fetch (pre-fetch) control algorithms may be utilized in advanced chipsets such as, for example, 440BX host bridge chipsets manufactured by Intel Corporation to enhance the memory efficiency. For instance, when a PCI read request is a PCI “memory read” command or “memory read line” command, a line of data is fetched. When a command is a PCI “memory read multiple”, multiple lines of data are fetched. Such a PCI read request may be a 4-bit command (such as, for example: “0110”, “1110” and “1100”) which indicates either a “memory read” command, a “memory read line” command, and a “memory read multiple” command as specified by the “PCI Local Bus Specification, Revision 2.2.” For example, the “memory read” command may be used to read or fetch a single Dword of 32-bit block of data. The “memory read line” command may be used to read or fetch more than a Dword (32-bit block of data) up to the next cache line (a complete cache line). The “memory read multiple” command may be used to read or fetch more than one cache line before disconnecting. However, the amount of data transfers between the PCI devices 190 on one side of the ICH 150 as shown in FIGs. 1A-1B, and the main memory 124 of the memory subsystem 120 may still require optimization.

Accordingly, the present invention advantageously provides an efficient and cost-effective data pre-fetch control mechanism 300 which fetches data from a memory subsystem on one side of a host bridge such as an ICH 150 to PCI devices on the other side of the host bridge and efficiently retains pre-fetched data based on PCI cycle termination in order to optimize PCI bus operations and performances with minimal logic gates.

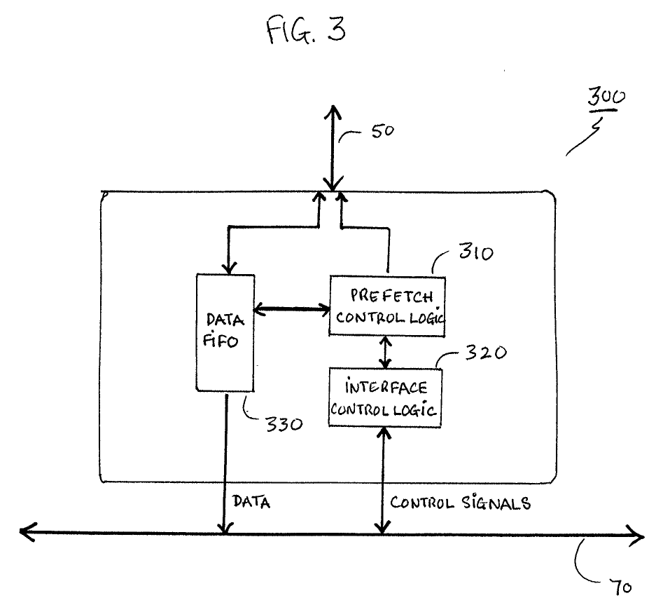

As shown in FIG. 3, the data pre-fetch control mechanism 300 according to an embodiment of the present invention may be integrated within the ICH 150 rather than having a separate chip formed as portion of the ICH 150. Such a data pre-fetch control mechanism 300 may comprise a pre-fetch control logic 310 arranged to control data fetch operations and retain pre-fetched data based on PCI cycle termination in order to optimize PCI bus operations and performances; an interface control logic 320 arranged to interface with the PCI bus 70; and a pre-fetch data FIFO (First-In, First-Out) 330 arranged to store pre-fetched data transfers among the processors 110a-110n, the main memory 124 and the PCI bus 70 so that the transfers of data in either direction may be accelerated to enhance the speed of data transfer in the computer system 100. In particular, the data FIFO 330 may correspond to a memory buffer (not shown) for holding pre-fetched data from the main memory 124 on one side (side A) of the ICH 150 for delivery to a particular PCI master (PCI device) 190 on the other side (side B) of the ICH 150, via the PCI bus 70.

When a PCI read request from the PCI master (PCI device) 190 to the main memory 124 is received by the interface control logic 320, the pre-fetch control logic 310 fetches several (e.g., 3) cache lines of data from the memory controller hub (MCH) 122. The memory controller hub (MCH) 122 then delivers the requested data back to the pre-fetch data FIFO 330. Depending on the configuration and the current activity of the system, the memory controller hub (MCH) 122 may not deliver the read data back-to-back. As a result, there are many common scenarios in which the interface control logic 320 must disconnect a read burst before the PCI master (PCI device) 190 has received all that it needs (i.e. PCI-bound writes and/or long latencies on the front-side bus 10 or DRAM interface 20).

The interface control logic 320 will disconnect a PCI master (PCI device) 190 if it cannot provide data. At this point, the pre-fetch control logic 310 will decide if it should flush or keep the remaining data. If the PCI master (PCI device) 190 wants to receive more data, then the pre-fetch control logic 310 will not flush the pre-fetched data. If, on the other hand, the PCI master (PCI device) 190 does not appear to want more data, then the pre-fetch control logic 310 may or may not flush the remaining pre-fetched data. The later decision is based on other system activity (e.g. another PCI read request needs to be service or a PCI-bound write request is pending).

Initial read requests to the main memory 124 (and the corresponding pre-fetch data FIFO 330 may be made larger. However, more gates for the larger pre-fetch FIFO 33 may be required which always results in more unnecessary read activity in the computer system 100 and does not solve the problem in which PCI-bound writes are posted in the middle of a read return data.

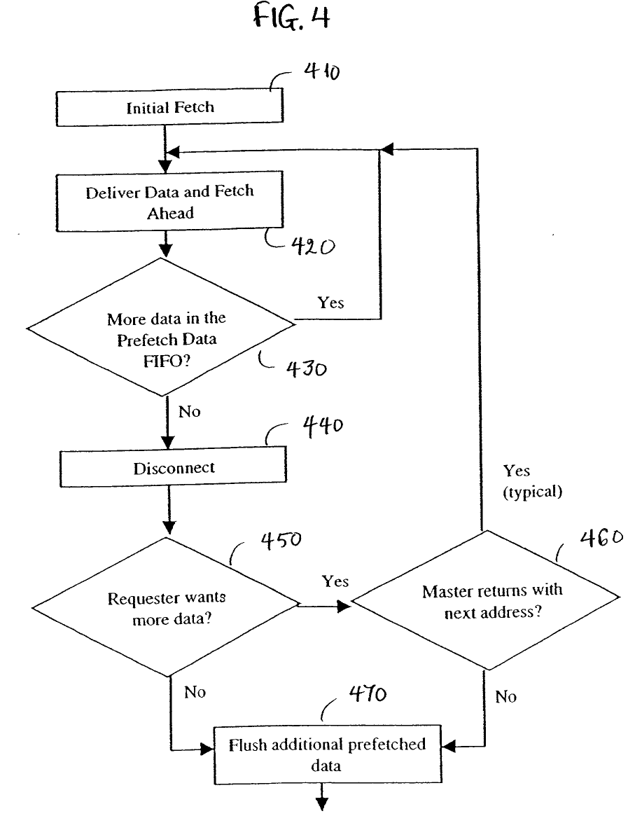

FIG. 4 illustrates a flow chart of an example data fetch (pre-fetch) operation performed by an example data pre-fetch control mechanism according to an embodiment of the present invention. As shown in FIG. 4, when a PCI read request is received from a PCI master (PCI device) 190, via the interface control logic 320 of the data pre-fetch control mechanism 300, for a data fetch (pre-fetch) operation at block 410, the pre-fetch control logic 310 fetches data from the main memory 124 into the data FIFO 330 and delivers pre-fetched data stored in the data FIFO 330 to the requesting PCI master 190, via the PCI bus 70. While delivering data to the PCI master 190, the pre-fetch control logic 310 also fetches data ahead from the main memory 124 pursuant to the PCI read request from the PCI master 190 at block 420.

The pre-fetch control logic 310 next determines whether there is more pre-fetched data stored in the data FIFO 330 at block 430. If there is more pre-fetched data stored in the data FIFO 330 at block 430, the pre-fetch control logic 310 continues to deliver pre-fetched data to the PCI master 190, via the PCI bus 70 and fetches data ahead from the main memory 124 at block 420 until there is no more pre-fetched data stored in the data FIFO 330 at block 430. When there is no more pre-fetched data stored in the data FIFO 330 at block 430, the pre-fetch control logic 310 disconnects the transaction at block 440.

Then the pre-fetch control logic 310 determines whether the PCI master (PCI device) 190 requests more data from the main memory 124 at block 450. If the PCI master (PCI device) 190 requests more data from the main memory 124, the pre-fetch control logic 310 determines whether the PCI master (PCI device) 190 returns a next address for memory read at block 460. If the PCI master (PCI device) 190 returns a next address for memory read at block 460, then the pre-fetch control logic 310 returns to block 420 to fetch data from the main memory 124 into the data FIFO 330 and deliver the pre-fetched data to the PCI master (PCI device) 190, via the PCI bus 70.

If the PCI master (PCI device) 190 does not request more data from the main memory 124 at block 450, the pre-fetch control logic 310 then flushes any additional pre-fetched data from the data FIFO 330 at block 470. Likewise, if the PCI master (PCI device) 190 does not return a next address for memory read at block 460, the pre-fetch control logic 310 may also flush any additional pre-fetched data from the data FIFO 330 based on predetermined conditions at block 470. Examples of those predetermined conditions may include, but not limited to: (1) when the PCI master (PCI device) 190 initiates the write transaction; (2) when the PCI master (PCI device) 190 initiates a peer-to-peer transaction (i.e., transaction that targets another agent on the PCI bus 70); and (3) when a pre-fetch data discard timer (not shown) expires.

As a result, unlike existing Intel Chipsets when the PCI master (PCI device) 190 is removed from the PCI bus 70 (either by itself or the ICH 150) and the pre-fetched data is always flushed, the example data pre-fetch control mechanism 300 according to an embodiment of the present invention makes decisions about PCI cycle termination to see if it should keep the pre-fetched data or flush the same in order to optimize PCI bus operations and performances with minimal logic gates.

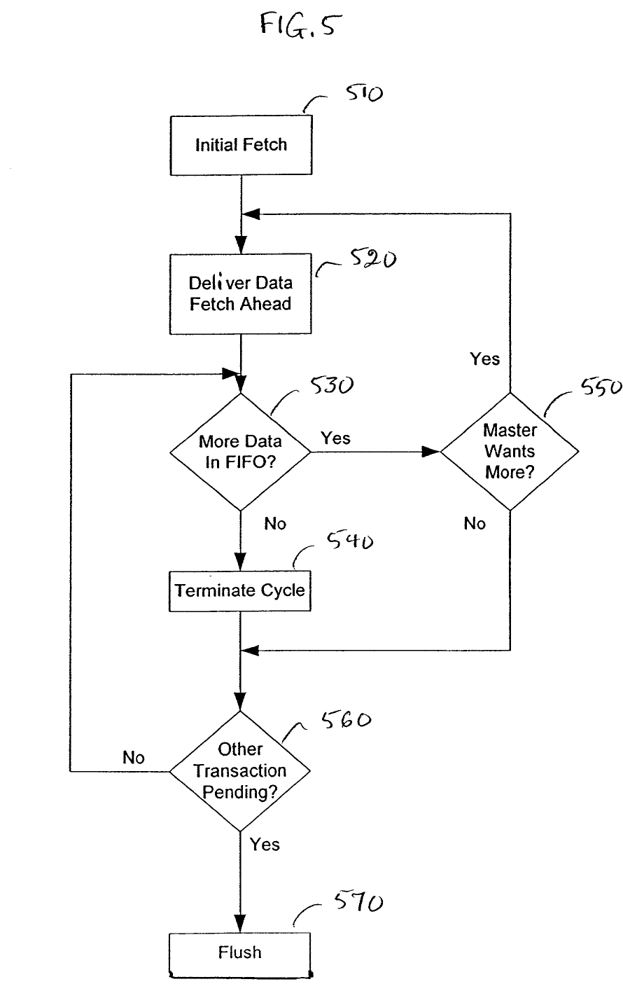

Turning now to FIG. 5, a flow chart of an example data fetch (pre-fetch) operation performed by an example data pre-fetch control mechanism according to an alternative embodiment of the present invention is illustrated. As shown in FIG. 5, when a PCI read request is received from a PCI master (PCI device) 190, via the interface control logic 320 of the data pre-fetch control mechanism 300, for a data fetch (pre-fetch) operation at block 510, the pre-fetch control logic 310 of the data pre-fetch control mechanism 300 fetches data from the main memory 124 into the data FIFO 330 and delivers pre-fetched data stored in the data FIFO 330 to the requesting PCI master 190, via the PCI bus 70. While delivering data to the PCI master 190, the pre-fetch control logic 310 also fetches data ahead from the main memory 124 pursuant to the PCI read request from the PCI master 190 at block 520.

The pre-fetch control logic 310 next determines whether there is more pre-fetched data stored in the data FIFO 330 at block 530. If there is no more pre-fetched data stored in the data FIFO 330 at block 530, the pre-fetch control logic 310 disconnects the transaction (or terminates PCI cycle) at block 540. However, if there is more pre-fetched data stored in the data FIFO 330 at block 530, the pre-fetch control logic 310 next determines whether the PCI master (PCI device) 190 requests more data from the main memory 124 at block 550. If the PCI master (PCI device) 190 requests more data from the main memory 124, the pre-fetch control logic 310 returns to block 520 to fetch data from the main memory 124 into the data FIFO 330 and deliver the pre-fetched data to the PCI master (PCI device) 190, via the PCI bus 70. If the PCI master (PCI device) 190 does not request more data from the main memory 124, the pre-fetch control logic 310 proceeds to block 560 to determine whether other transaction is pending.

If no other transaction is pending at block 560, the pre-fetch control logic 310 proceeds to block 530 to determine whether there is more pre-fetched data stored in the data FIFO 330. However, if there is another transaction pending at block 560, the pre-fetch control logic 310 flushes any additional pre-fetched data from the data FIFO 330 at block 570.

As described with reference to FIGS. 3-5, decisions about PCI cycle termination are made before pre-fetched data is retained or flushed. This way the cost of the ICH 150 is reduced by allowing PCI-bound writes to share the same FIFO as PCI initiated read requests with minimal impact to PCI read performance. PCI burst read bandwidth is more immune to memory fetch latencies. Wasteful pre-fetch traffic is greatly reduced on system interfaces between PCI and main memory (DRAM interface, processor front-side bus, and hub link interface) which allows a single ICH product to provide robust PCI read performance across the whole spectrum of memory controllers (server down to basic PC) without requiring large pre-fetch data FIFOs nor overwhelming the system buses with data accesses that will likely just be flushed for low end systems.

In addition, the pre-fetch control logic 310 of the data pre-fetch control mechanism 300 may also be supplemented with an array of logics implemented to optimize pre-fetch data transfers of an appropriate size from a main memory 124 on one side (side A) of a host bridge such as an ICH 150 for a PCI master (PCI device) 190 to another side of the ICH 150 in accordance with a particular request, such as a specific PCI read request, a bus data width (REQ#64), a bus frequency (M66EN) and an optional cache line size. More specifically, such a pre-fetch control logic 310 may be implemented to receive input variables such as the command type (memory read, memory read line, and memory read multiple), REQ#64 and M66EN signals and cache line size, and generate corresponding fetch values indicating a fetch size of data to be fetched from main memory 124 on side A of the ICH 150 for a requesting PCI device 190 on side B of the ICH 150. The fetch values may be provided from a look-up table (not shown) based upon latency calculations specific to the computer system platform as shown in FIGs. 1A-1B.

The PCI read request as previously described, may be a 4-bit command (such as, for example: “0110”, “1110” and “1100”) which indicates either a “memory read” command, a “memory read line” command, and a “memory read multiple” command as specified by the “PCI Local Bus Specification, Revision 2.2.” For example, the “memory read” command may be used to read or fetch a single Dword (32-bit block of data). The “memory read line” command may be used to read or fetch more than a Dword (32-bit block of data) up to the next cache line (a complete cache line). The “memory read multiple” command may be used to read or fetch more than one cache line before disconnecting.

In addition to the PCI read request, the bus frequency, the bus data width and cache line size may be utilized to determine variable fetch sizes in order to fetch optimized data from main memory 124 of the memory subsystem 120 for PCI devices 190 on one side of the ICH 150. The bus frequency may indicate, for example, either 33 MHz or 66 MHz, based upon M66EN (66MHz_ENABLE) used as an input. The bus frequency may run at 33 to 66 MHz if M66EN is asserted, and 0 to 33 MHz if M66EN is de-asserted. In other words, the M66EN may be used to indicate to the current PCI master (PCI device) 190 whether a PCI bus 70 is operating at either 33 MHz or 66 MHz, or any other operating speed. The bus data width may indicate either 32 bits or 64 bits, for example, based upon REQ64# assertion by the PCI device 190. The REQ64# may correspond to a 64-bit request. In other words, the data transfer may be at 64 bits if RBQ64# is asserted by the current PCI master (PCI device) 190, and may be 32 bits if REQ64# is de-asserted by the current PCI master (PCI device) 190. Lastly, the cache line size may be either 32 bytes or 64 bytes, based upon an internal register in a host bridge such as the ICH 150. The length of a cache line may be defined by the Cacheline Size register in Configuration Space which is initialized by configuration software of the host bridge.

As described from the foregoing, the present invention advantageously provides a data pre-fetch control mechanism and algorithm implemented to effectively fetch optimized data from a memory subsystem on one side of a host bridge for a PCI device on the other side of such a host bridge in such a manner as to obtain high performance to the PCI device and higher system performance.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, the computer system as shown in FIGS. 1 and 2 may be configured differently or employ some or different components than those illustrated. In addition, the data pre-fetch control mechanism shown in FIGS. 3-5 may be configured differently or employ some or different components than those illustrated without changing the basic function of the invention. Moreover, different combinations of logic gates may be used to correspond input variables such as the command type (memory read, memory read line, and memory read multiple), REQ#64 and M66EN signals, and also optional cache line size with output fetch values for fetching data from a memory subsystem on one side of a host bridge to a designated PCI device on the other side of the host bridge. Additionally, alternative bus widths and frequencies may be used as both bus widths and bus frequencies tend to increase as technology advances. Further, software equivalents to the data fetch control mechanism as shown in FIGS. 3-5 may be available to fetch data from a memory subsystem on one side of a host bridge to the PCI devices on the other side of the host bridge. Many modifications may be made to adapt the teachings of the present invention to a particular situation without departing from the scope thereof. Therefore, it is intended that the present invention not be limited to the various exemplary embodiments disclosed, but that the present invention includes all embodiments falling within the scope of the appended claims.

What is claimed is:

1. A data pre-fetch control mechanism, comprising:
an interface control logic arranged to interface with a bus;
a data buffer arranged to store pre-fetched data from a main memory to a requesting bus device, via said bus; and
a pre-fetch control logic operatively connected to said interface control logic and said data buffer, and arranged to control data fetch operations and retain pre-fetched data after bus cycle termination to optimize bus operations and performances.

2. The mechanism as claimed in claim 1, wherein said bus corresponds to a Peripheral Component Interconnect (PCI) bus, said requesting bus device corresponds to a requesting PCI master connected to said PCI bus, and said data buffer corresponds to a data first-in, first-out (FIFO) for retaining pre-fetched data from said main memory on one side of an I/O controller hub (ICH) for delivery to the requesting PCI master to another side of said ICH, via said PCI bus.

3. The mechanism as claimed in claim 1, wherein said pre-fetch control logic is configured to make decisions about said bus cycle termination to determine if the pre-fetched data is to be flushed so as to optimize bus operations and performances.

4. The mechanism as claimed in claim 2, wherein said pre-fetch control logic is configured to:
fetch data from said main memory to said data FIFO and deliver pre-fetched data stored in said data FIFO to the requesting PCI master, via said PCI bus, when a PCI read request is received from the requesting PCI master, via said interface control logic;
determine whether there is more pre-fetched data stored in said data FIFO;
if there is more pre-fetched data stored in said data FIFO, continue to deliver pre-fetched data to the requesting PCI master, via said PCI bus, and fetch data ahead from the main memory until there is no more pre-fetched data stored in said data FIFO;
if there is no more pre-fetched data stored in said data FIFO, disconnect the transaction;
determine whether the requesting PCI master requests more data from said main memory;
if the requesting PCI master requests more data from said main memory, determine whether the requesting PCI master returns a next address for a memory read;
if the requesting PCI master returns a next address for said memory read, return to fetch data from said main memory to said data FIFO and deliver the pre-fetched data to the requesting PCI master, via the PCI bus;
if the requesting PCI master does not request more data from said main memory, flush any additional pre-fetched data from said data FIFO; and
if the requesting PCI master does not return a next address for said memory read, flush any additional pre-fetched data from said data FIFO based on predetermined conditions.

5. The mechanism as claimed in claim 2, wherein said pre-fetch control logic is configured to:
fetch data from said main memory to said data FIFO and deliver pre-fetched data stored in said data FIFO to a requesting PCI master, via said PCI bus, when a PCI read request is received from the requesting PCI master, via said interface control logic;
determine whether there is more pre-fetched data stored in said data FIFO;
if there is no more pre-fetched data stored in said data FIFO, disconnect the transaction and determine whether said data FIFO must be flushed for other pending transactions;
if there is more pre-fetched data stored in said data FIFO, determine whether the requesting PCI master requests more data from said main memory;
if the requesting PCI master requests more data from the main memory, return to fetch data from said main memory to said data FIFO and deliver the pre-fetched data to the requesting PCI master, via said PCI bus,
if the requesting PCI master does not request more data from said main memory, proceed to determine whether other transaction is pending;
if no other transaction is pending, proceed to determine whether there is more pre-fetched data stored in said data FIFO; and
alternatively, if there is another transaction pending, flush any additional pre-fetched data from said data FIFO.

6. The mechanism as claimed in claim 2, wherein said pre-fetch control logic is further implemented to receive variables of said PCI read request, a bus frequency, and a bus data width signal from the requesting PCI master, and to generate fetch sizes of data to be fetched from the main memory to the requesting PCI master as a function of said PCI read request, said bus frequency, and said bus data width signal.

7. The mechanism as claimed in claim 6, wherein said PCI read request corresponds to one of a memory read command, a memory read line command, and a memory read multiple command for reading different amount of data from said main memory during a read cycle.

8. The mechanism as claimed in claim 6, wherein said bus frequency corresponds to one of 33 MHz and 66 MHz, based upon assertion of 66MHz_ENABLE pin from the requesting PCI master connected to said PCI bus, and said bus data width signal corresponds to one of 32 bits and 64 bits, based upon assertion of REQ64# pin from the requesting PCI master connected to said PCI bus.

9. A computer system, comprising:
a memory subsystem;
a host chipset connected to said memory subsystem; and
a bus device connected to said host chipset, via a bus;
said host chipset comprising a data pre-fetch control mechanism for fetching data from said memory subsystem for said bus device and retaining pre-fetched data based on bus cycle termination, said data pre-fetch control mechanism comprising:
an interface control logic arranged to interface with said bus;
a data FIFO arranged to store pre-fetched data from said memory subsystem to a requesting bus device, via said bus; and
a pre-fetch control logic operatively connected to said interface control logic and said data FIFO, and arranged to control data fetch operations and retain pre-fetched data after said bus cycle termination to optimize bus operations and performances.

10. The computer system as claimed in claim 9, wherein said bus corresponds to a Peripheral Component Interconnect (PCI) bus, said requesting bus device corresponds to a requesting PCI master connected to said PCI bus.

11. The computer system as claimed in claim 10, wherein said host chipset corresponds to one of an I/O Controller Hub (ICH) and a Peripheral Component Interconnect (PCI) 64-bit hub.

12. The computer system as claimed in claim 9, wherein said pre-fetch control logic is configured to make decisions about said bus cycle termination to determine if the pre-fetched data is to be flushed so as to optimize bus operations and performances.

13. The computer system as claimed in claim 10, wherein said pre-fetch control logic is configured to:
fetch data from said memory subsystem to said data FIFO and deliver pre-fetched data stored in said data FIFO to the requesting PCI master, via said PCI bus, when a PCI read request is received from the requesting PCI master, via said interface control logic;
determine whether there is more pre-fetched data stored in said data FIFO;
if there is more pre-fetched data stored in said data FIFO, continue to deliver pre-fetched data to the requesting PCI master, via said PCI bus, and fetch data ahead from said memory subsystem until there is no more pre-fetched data stored in said data FIFO;
if there is no more pre-fetched data stored in said data FIFO, disconnect the transaction;
determine whether the requesting PCI master requests more data from said memory subsystem;
if the requesting PCI master requests more data from said memory subsystem, determine whether the requesting PCI master returns a next address for a memory read;
if the requesting PCI master returns a next address for said memory read, return to fetch data from said memory subsystem to said data FIFO and deliver the pre-fetched data to the requesting PCI master, via the PCI bus;
if the requesting PCI master does not request more data from said memory subsystem, flush any additional pre-fetched data from said data FIFO; and
if the requesting PCI master does not return a next address for said memory read, flush any additional pre-fetched data from said data FIFO based on predetermined conditions.

14. The computer system as claimed in claim 10, wherein said pre-fetch control logic is configured to:
fetch data from said memory subsystem to said data FIFO and deliver pre-fetched data stored in said data FIFO to a requesting PCI master, via said PCI bus, when a PCI read request is received from the requesting PCI master, via said interface control logic;
determine whether there is more pre-fetched data stored in said data FIFO;
if there is no more pre-fetched data stored in said data FIFO, disconnect the transaction and determine whether said data FIFO must be flushed for other pending transactions;
if there is more pre-fetched data stored in said data FIFO, determine whether the requesting PCI master requests more data from said memory subsystem;
if the requesting PCI master requests more data from said memory subsystem, return to fetch data from said memory subsystem to said data FIFO and deliver the pre-fetched data to the requesting PCI master, via said PCI bus,
if the requesting PCI master does not request more data from said memory subsystem, proceed to determine whether other transaction is pending;
if no other transaction is pending, proceed to determine whether there is more pre-fetched data stored in said data FIFO; and
alternatively, if there is another transaction pending, flush any additional pre-fetched an data from said data FIFO.

15. The computer system as claimed in claim 10, wherein said pre-fetch control logic is further implemented to receive variables of said PCI read request, a bus frequency, and a bus data width signal from the requesting PCI master, and to generate fetch sizes of data to be fetched from the main memory to the requesting PCI master as a function of said read command, said bus frequency, and said bus data width signal.

16. The computer system as claimed in claim 15, wherein said PCI read request corresponds to one of a memory read command, a memory read line command, and a memory read multiple command for reading different amount of data from the main memory during a read cycle.

17. The computer system as claimed in claim 16, wherein said bus frequency corresponds to one of 33 MHz and 66 MHz, based upon assertion of 66MHz_ENABLE pin from the requesting PCI master connected to said PCI bus, and said bus data width signal corresponds to one of 32 bits and 64 bits, based upon assertion of REQ64# pin from the requesting PCI master connected to said PCI bus.

18. A data pre-fetch method comprising:
receiving a PCI read request from a requesting PCI master, via a PCI bus;
in response to said PCI read request, fetching data from a memory subsystem to a data FIFO and delivering pre-fetched data stored in said data FIFO to the requesting PCI master, via said PCI bus;
determining whether there is more pre-fetched data stored in said data FIFO;
if there is more pre-fetched data stored in said data FIFO, continuing to deliver pre-fetched data to the requesting PCI master, via said PCI bus, and fetching data ahead from said memory subsystem until there is no more pre-fetched data stored in said data FIFO;
if there is no more pre-fetched data stored in said data FIFO, disconnecting the transaction;
determining whether the requesting PCI master requests more data from said memory subsystem;
if the requesting PCI master requests more data from said memory subsystem, determining whether the requesting PCI master returns a next address for a memory read;
if the requesting PCI master returns a next address for said memory read, returning to fetch data from said memory subsystem to said data FIFO and deliver the pre-fetched data to the requesting PCI master, via the PCI bus;
if the requesting PCI master does not request more data from said memory subsystem, flushing any additional pre-fetched data from said data FIFO; and
if the requesting PCI master does not return a next address for said memory read, flushing any additional pre-fetched data from said data FIFO based on predetermined conditions.

19. A data pre-fetch method comprising:
receiving a PCI read request from a requesting PCI master, via a PCI bus;
in response to said PCI read request, fetching data from a memory subsystem to a data FIFO and delivering pre-fetched data stored in said data FIFO to the requesting PCI master, via said PCI bus;
determining whether there is more pre-fetched data stored in said data FIFO;
if there is no more pre-fetched data stored in said data FIFO, disconnecting the transaction and determining whether said data FIFO must be flushed for other pending transactions;
if there is more pre-fetched data stored in said data FIFO, determining whether the requesting PCI master requests more data from said memory subsystem;
if the requesting PCI master requests more data from said memory subsystem, returning to fetch data from said memory subsystem to said data FIFO and deliver the pre-fetched data to the requesting PCI master, via said PCI bus,
if the requesting PCI master does not request more data from said memory subsystem, proceeding to determine whether other transaction is pending;
if no other transaction is pending, proceeding to determine whether there is more pre-fetched data stored in said data FIFO; and
alternatively, if there is another transaction pending, flushing any additional pre-fetched data from said data FIFO based on predetermined conditions.

20. The method as claimed in claim 19, wherein said PCI read request corresponds to one of a memory read command, a memory read line command, and a memory read multiple command for reading different amount of data from said memory subsystem during a read cycle.
